(19) United States
(12) Patent Application Publication
(10) Pub. No.: US 2007/0071075 A1
(43) Pub. Date: Mar. 29, 2007

(54) Apparatus and method for detecting fast feedback information in multi-cell base station in a broadband wireless communication system

(75) Inventors: Ha-Young Yang, Yongin-si (KR); Joon-Young Bae, Seoul (KR); Jae-Ho Jeon, Seongnam-si (KR); Seung-Joo Maeng, Seongnam-si (KR)

Correspondence Address: DILWORTH & BARRESE, LLP, 333 EARLE OVINGTON BLVD., SUITE 702, UNIONDALE, NY, 11553, US

(73) Assignee: Samsung Electronics Co., Ltd., Suwon-si (KR)

(21) Appl. No.: 11/523,973

(22) Filed: Sep. 20, 2006

(30) Foreign Application Priority Data
Sep. 27, 2005 (KR) 2005-0089869

(51) Int. Cl. H04B 1/00; H04K 1/10

(52) U.S. Cl. 375/150; 375/260

(57) ABSTRACT

An apparatus and method for detecting a feedback signal in a multi-cell or multi-sector sector BS in a broadband wireless communication system are provided. A demodulator correlates each tile being sets of subcarriers carrying feedback information received from a serving sector/cell with each possible codeword and calculates the squares of the absolute values of the correlations of the tiles for each possible codeword. A first detection decider sums the squares for each possible codeword and determines whether to perform detection on the received feedback information. If it is impossible to detect the feedback information, a second detection decider receives feedback information from a target sector/cell, combines the feedback information received from the serving sector/cell and the target sector/cell, and determines whether to detect the combined feedback information.

### PRIORITY

This application claims priority under 35 U.S.C. § 119 to an application entitled “Apparatus and Method for Detecting Fast Feedback Information in Multi-Cell Base Station in a Broadband Wireless Communication System” filed in the Korean Intellectual Property Office on Sep. 27, 2005 and assigned Serial No. 2005-89869, the contents of which are incorporated herein by reference.

### BACKGROUND OF THE INVENTION

1. Field of the Invention

The present invention relates generally to an apparatus and method for detecting feedback information in a broadband wireless communication system, and in particular, to an apparatus and method for detecting uplink fast feedback information in a multi-cell or multi-sector Base Station (BS) in a broadband wireless communication system.

2. Description of the Related Art

In a high-speed mobile communication system, a BS schedules packet data transmission and determines transmission parameters using uplink fast feedback information representing downlink channel quality, in order to provide a high-speed packet data service to Mobile Stations (MSs). Upon receipt of the uplink fast feedback signals from the MSs, the BS checks the downlink channel statuses to the MSs based on the feedback information. The BS then selects MSs having the best downlink channel quality according to the channel status information in every slot and sends packet data to the selected MSs. The BS also determines transmission parameters (e.g. data rate, code rate, and modulation order) according to the downlink channel quality of the selected MSs. The uplink fast feedback information may include a Signal-to-Noise Ratio (SNR), a Carrier-to-Interference Ratio (C/I), the differential SNR of each band, a fast Multiple Input Multiple Output (MIMO) feedback, or a mode selection feedback. Additional physical channels are configured for delivering the uplink fast feedback information in a communication system, for example an Orthogonal Frequency Division Multiple Access (OFDMA) communication system.

The BS uses C/Is measured at the MSs in determining the downlink channel quality. The MSs measure C/Is and feed back the C/I measurements to the BS on physical channels, e.g. Channel Quality Indicator CHannels (CQICHs). The BS schedules downlink data for the MSs and determines transmission parameters based on the C/I measurements.

The C/I information, by which downlink data rates and cell throughput are determined, has to be sent with high reliability despite its small size, because it is very critical to the operation of the communication system. Yet, it is typical not to allocate much time-frequency resources to the physical channels carrying the fast feedback information in order to reduce an overhead rate. Accordingly, there exists a need for an efficient detection method to enable reliable transmission.

FIG. 1 is a flowchart illustrating a conventional feedback information detecting operation. The following description is based on the assumption that each tile is defined by 3×3 subcarriers and an MS feeds back 4-bit information data.

Referring to FIG. 1, a BS monitors reception of an uplink fast feedback signal in step 101. Upon receipt of the feedback signal, the BS converts the received time-domain feedback signal to a frequency signal by Fast Fourier Transform (FFT) in step 103.

In step 105, the BS separates tiles from the FFT feedback signal, correlates modulation symbols on eight subcarriers in each of the tiles with an orthogonal vector corresponding to the tile in each codeword, and squares the absolute value of the correlation of the tile.

The BS then sums the squares of the absolute values of the correlations of six tiles for each of 16 possible codewords, selects the maximum (MAX) of the sums, and calculates the average (AVG) of the sums with respect to the 16 codewords in step 107.

In step 109, the BS compares the difference between the maximum and the average with a predetermined threshold (Th). If the difference is less than the threshold ((MAX−AVG)<Th), the BS discards the feedback signal without performing detection, determining that the feedback signal is not reliable in step 113.

On the other hand, if the difference between the maximum and the average is greater than or equal to the threshold ((MAX−AVG)≧Th), the BS performs detection, taking into consideration that the information data of the codeword with the maximum is reliable in step 111. Then the BS ends the algorithm.

FIGS. 2 and 3 illustrate codewords that can be generated from an M-ary channel encoder.

FIG. 2 is a table listing 2⁴ (=16) codewords that can be generated from 4-bit information data, and FIG. 3 is a table listing 2⁶ (=64) codewords that can be generated from 6-bit information data.

FIG. 4 illustrates orthogonal vectors used for orthogonal modulation of the codewords of FIGS. 2 and 3.

$$P 0 ( exp ( j \frac{π}{4} ) ) , P 1 ( exp ( j \frac{3 π}{4} ) ) , P 2 ( exp ( - j \frac{3 π}{4} ) ) , and P 3 ( exp ( - j \frac{π}{4} ) )$$

are Quadrature Phase Shift Keying (QPSK) symbols. Pilot symbols, which are known to both the BS and the MS, are generally multiplied by a scrambling code and modulated in Binary Phase Shift Keying (BPSK).

As described above, an uplink subchannel carries uplink fast feedback information. Conventionally, information bits are determined using only a fast feedback signal received in a serving BS managing a corresponding cell or sector. Therefore, in case where the uplink fast feedback information is scattered due to some obstacle and thus received in a target cell, detection of the fast feedback information suffers from information loss.

### SUMMARY OF THE INVENTION

An aspect of the present invention is to substantially solve at least the above problems and/or disadvantages and to provide at least the advantages below. Accordingly, an aspect of the present invention is to provide an apparatus and method for efficiently detecting uplink fast feedback information using time-frequency resources in a multi-cell or multi-sector BS in a broadband wireless communication system.

Another aspect of the present invention is to provide an apparatus and method for efficiently detecting uplink fast feedback information using uplink fast feedback information received in a target cell or sector of a multi-cell or multi-sector BS as well as uplink fast feedback information received in a serving cell or sector of the multi-cell or multi-sector BS.

The above aspects are achieved by providing an apparatus and method for detecting a feedback signal in a multi-cell or multi-sector sector BS in a broadband wireless communication system

According to one aspect of the present invention, in an apparatus for detecting a feedback signal in a multi-sector BS in a broadband wireless communication system, a demodulator correlates modulation symbols and pilot symbols included in each tile carrying feedback information received from a serving sector with each possible codeword, and calculates the squares of the absolute values of the correlations of the tiles for each possible codeword. Each tile is a set of subcarriers. A first detection decider sums the squares of the absolute values of the correlations of the tiles for each possible codeword, and determines whether to perform detection on the received feedback information according to the sums for the possible codewords. If it is impossible to detect the feedback information received from the serving sector, a second detection decider receives feedback information from a target sector, combines the feedback information received from the serving sector with the feedback information received from the target sector, and determines whether to perform detection on the combined feedback information.

According to another aspect of the present invention, in a method of detecting feedback information in a multi-sector BS in a broadband wireless communication system, it is determined whether to perform detection on feedback information received from a serving sector. If it is impossible to detect the feedback information received from the serving sector, reception of feedback information from a target sector is monitored. Upon receipt of the feedback information from the target sector, the feedback information received from the serving sector is combined with the feedback information received from the target sector, and it is determined whether to perform detection on the combined feedback information.

According to a further aspect of the present invention, in an apparatus for detecting a feedback signal in a multi-cell BS in a broadband wireless communication system, a demodulator correlates modulation symbols and pilot symbols included in each tile carrying feedback information received from a serving cell with each possible codeword, and calculates the squares of the absolute values of the correlations of the tiles for each possible codeword. Each tile is a set of subcarriers. A first detection decider sums the squares of the absolute values of the correlations of the tiles for each possible codeword, and determines whether to perform detection on the received feedback information according to the sums for the possible codewords. If it is impossible to detect the feedback information received from the serving cell, a second detection decider receives feedback information from a target cell, combines the feedback information received from the serving cell with the feedback information received from the target cell, and determines whether to perform detection on the combined feedback information.

According to still another aspect of the present invention, in a method of detecting feedback information in a multi-cell BS in a broadband wireless communication system, it is determined whether to perform detection on feedback information received from a serving cell. If it is impossible to detect the feedback information received from the serving cell, reception of feedback information from a target cell is monitored. Upon receipt of the feedback information from the target cell, the feedback information received from the serving cell is combined with the feedback information received from the target cell, and it is determined whether to perform detection on the combined feedback information.

### BRIEF DESCRIPTION OF THE DRAWINGS

The above and other objects, features and advantages of the present invention will become more apparent from the following detailed description when taken in conjunction with the accompanying drawings in which:

FIG. 1 is a flowchart illustrating a conventional feedback information detecting operation;

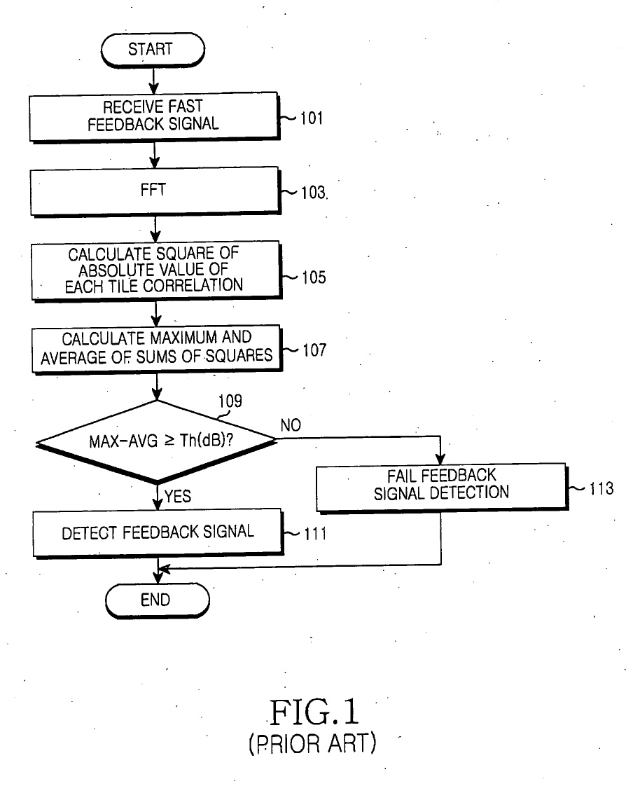

FIG. 2 illustrates a table of typical codewords that can be output from a channel encoder, for the input of 4-bit information data;

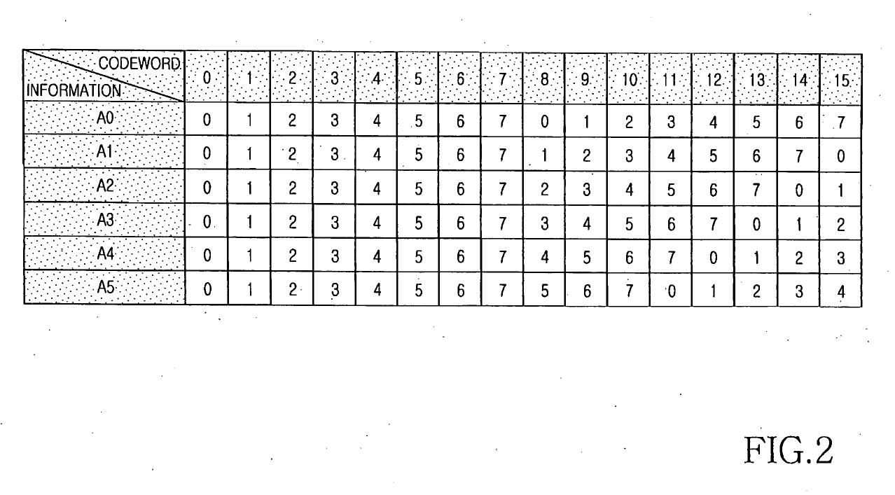

FIG. 3 illustrates a table of typical codewords that can be output from the channel encoder, for the input of 6-bit information data;

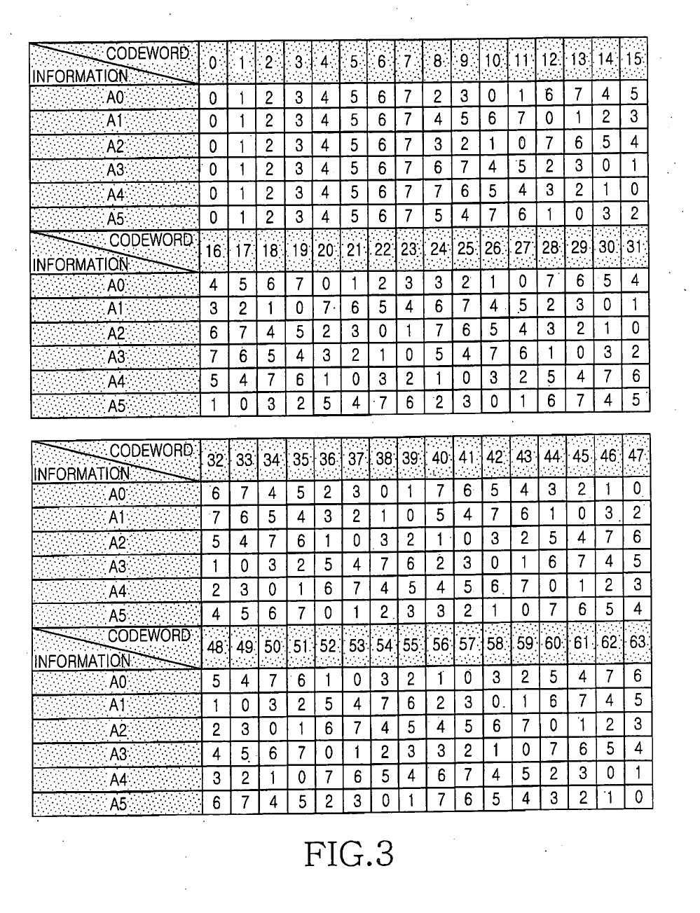

FIG. 4 illustrates a table of typical orthogonal vectors for use in modulation;

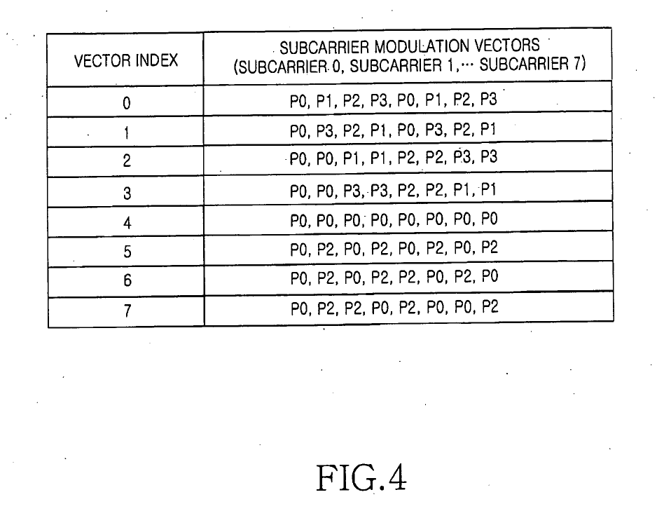

FIG. 5 illustrates an uplink fast feedback signal received in a multi-cell BS according to the present invention;

FIG. 6 is a block diagram of the multi-cell BS for receiving feedback information according to the present invention;

FIG. 7 is a block diagram of an apparatus for determining detection of feedback information in the BS according to the present invention,

FIG. 8 is a flowchart illustrating a feedback information detecting operation according to the present invention; and

FIG. 9 is a flowchart illustrating a feedback information detecting operation according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

The present invention provides a technique for detecting uplink fast feedback information in a multi-cell or multi-sector BS using uplink fast feedback information received in a target cell or sector as well as uplink fast feedback information received in a serving cell or sector. The multi-cell or multi-sector BS is a BS that simultaneously covers multiple cells or sectors. When each cell or sector has one processing module, the multi-cell or multi-sector BS combines signals received from the cells or sectors by connecting interfaces among them. In the case of one processing module per multi-cell or multi-sector BS, a modem can be implemented in software to combine signals received from the cells or sectors in the multi-cell or multi-sector BS.

The following description is made in the context of an OFDMA broadband wireless communication system and also in the context of a multi-sector structure. The same description applies to a multi-cell structure.

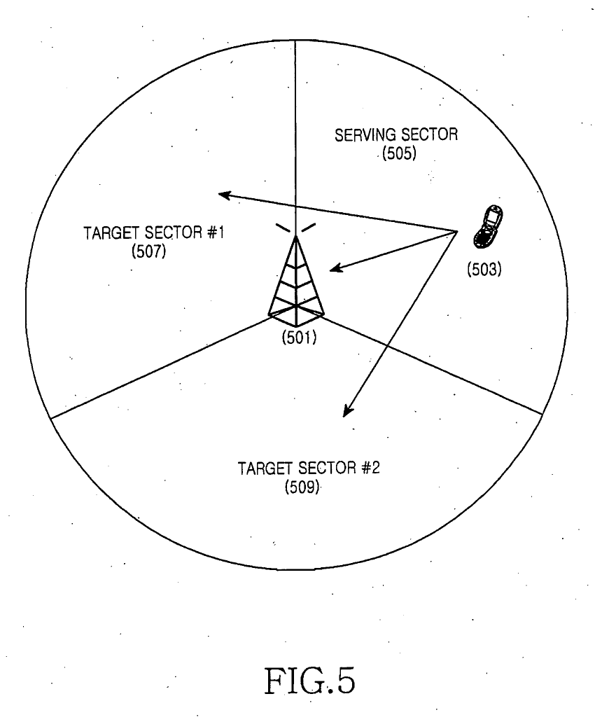

FIG. 5 illustrates an uplink fast feedback signal received in a multi-sector BS according to the present invention.

Referring to FIG. 5, when an MS 503 within a serving sector 505 of a multi-sector BS 501 sends an uplink fast feedback signal to the BS 501, the feedback signal is scattered by reflection and thus propagated to target sectors 507 and 509 as well a to the serving sector 505. According to the present invention, the feedback signal received in the serving sector is combined with the reflected signals received in the target sectors in order to perform data detection efficiently with less information loss.

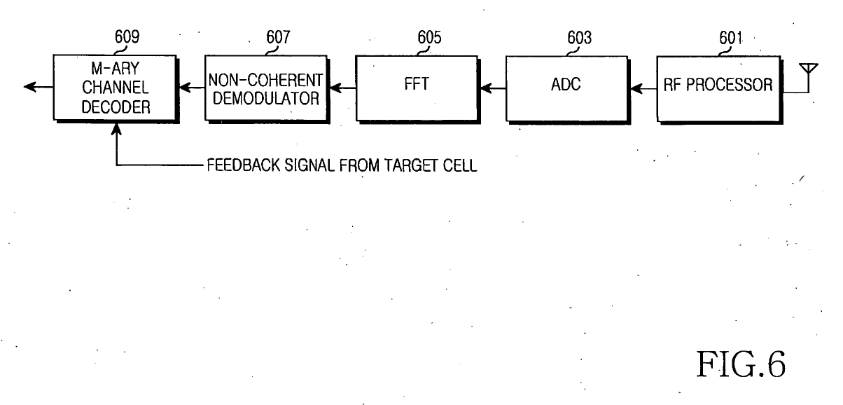

FIG. 6 is a block diagram of the multi-sector BS for receiving feedback information according to the present invention.

Referring to FIG. 6, the BS includes a Radio Frequency (RF) processor 601, an Analog-to-Digital Converter (ADC) 603, a Fast Fourier Transform (FFT) processor 605, a non-coherent demodulator 607, and a channel decoder 609.

The RF processor 601 downconverts an RF signal of feedback information received through an antenna to a baseband analog signal. The ADC 603 converts the analog signal to a digital signal. The FFT processor 605 converts time sample data received from the ADC 603 to frequency data by FFT.

The non-coherent demodulator 607 calculates soft-decision values of the FFT symbols by non-coherent demodulation. The channel decoder 609 determines the reliability of the received feedback information based on the soft-decision values. If the feedback information is reliable, the soft-decision values are decoded at a predetermined code rate, a codeword corresponding to the soft-decision values is determined, and data of the codeword is demodulated.

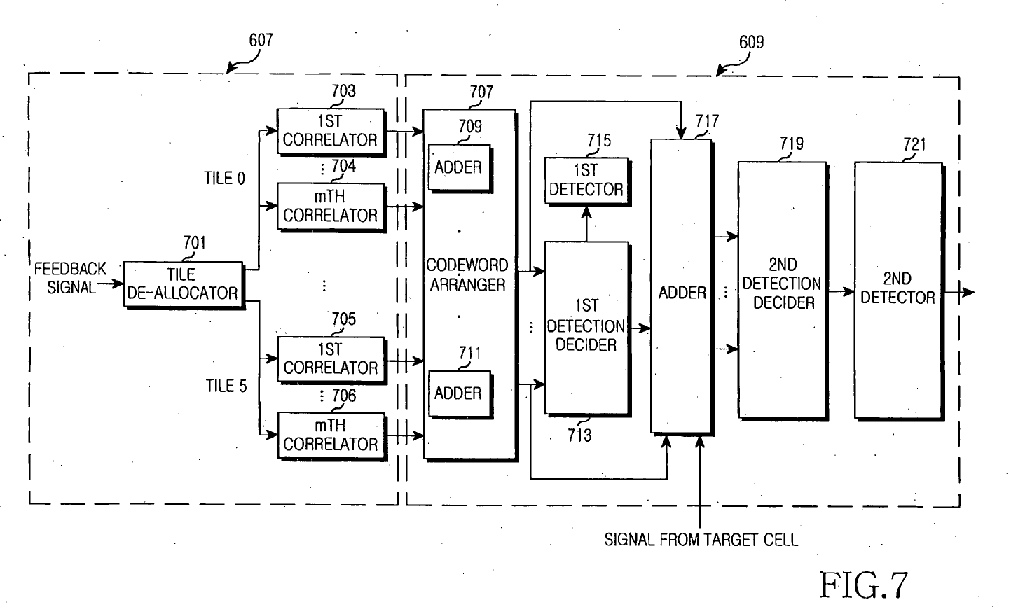

If the feedback information is received in the serving sector, the channel decoder 609 receives a decoded fast feedback signal from a target sector, combines the feedback signals of the serving sector and the target sector, and determines the reliability of the feedback signal again, which will be described in detail with reference to FIG. 7.

FIG. 7 is a block diagram of an apparatus for determining detection of feedback information in the BS according to the present invention. The following description is based on the assumption that each tile is defined by 3×3 subcarriers and 4-bit information data is used.

Referring to FIG. 7, in the BS, the non-coherent demodulator 607 includes a tile de-allocator 701 and correlators 703 to 706. The channel decoder 609 includes a codeword arranger 707, detection deciders 713 and 719, detectors 715 and 721, and an adder 717.

The tile de-allocator 701 separates six tiles each including 3×3 subcarriers from the FFT symbols received from the FFT processor 605 illustrated in FIG. 6. For example, when one subchannel is composed of six tiles, the six tiles are separated from the subchannel.

The correlators 703 to 706 correlate the subcarriers (i.e. tones) of each of the tiles with each codeword and squares the absolute value of the correlation. Specifically, a received 3×3 subcarrier set (tile) with modulation symbols on eight subcarriers and a pilot symbol on one subcarrier is correlated with a 3×3 subcarrier set with symbols corresponding to an orthogonal vector in a codeword and a pilot transmission symbol.

The codeword arranger 707 sums the squares of the absolute values of the correlations of the tiles for each of 16 codewords (codeword 0 to codeword 15) through adders 709 to 711. Then the codeword arranger 707 calculates the average of the sums with respect to the 16 codewords.

The first detection decider 713 selects the maximum of the sums received from the codeword arrangers 707 and compares the difference between the maximum and the average with a threshold, thereby determining whether to detect the feedback information.

If the difference between the maximum and the average is greater than or equal to the threshold ((MAX−AVG)≧Th), the first detection decider 713 sends the feedback information to the first detector 715, considering that the received feedback information is reliable. The first detector 715 detects the feedback information.

On the other hand, if the difference is less than the threshold ((MAX−AVG)<Th), the first detection decider 713 considers that the reception environment of the feedback signal is poor and outputs the feedback signal to the adder 717, so that the feedback signal is detected using a feedback signal received in the target sector.

For every possible codeword, the adder 717 adds the sum of the squares of the absolute values of the correlations of the feedback signal received from the first detection decider 713 to the sum of the squares of the absolute values of the correlations of a feedback signal received from the target sector. The feedback signal from the MS within the serving sector is scattered under a channel environment and then reaches to the target sector. Thus, the target sector calculates the sum of the squares of the absolute values of the correlations of the feedback signal with respect to every possible codeword. Since the target sector has knowledge of the environment of the serving sector (e.g. information about slots allocated to the MS), it can carry out the correlation.

The second detection decider 719 selects the maximum (MAX_{SUM}) of the sums received from the adder 717 and calculates the average (AVG_{SUM}) of the sums with respect to all the codewords. Then the second detection decider 719 compares the difference between the maximum sum and the average sum with a threshold, thereby determining whether to detect the feedback information.

If the difference between the maximum sum and the average sum is greater than or equal to the threshold ((MAX_{SUM}−AVG_{SUM})≧Th), the second detection decider 719 sends the combination between the received feedback signal and the feedback signal received in the target sector to the second detector 721, considering that the combined feedback information is reliable. The second detector 719 detects the combined feedback information.

On the other hand, if the difference is less than the threshold ((MAX−AVG)<Th), the second detection decider 719 discards the feedback signal, considering that the reception environment of the feedback signal is poor.

In the above-described embodiment, each of the first and second detection deciders 713 and 719 determines whether to detect the feedback signal by comparing the difference between MAX and AVG (or the difference between MAX_{SUM} and AVG_{SUM}) with the threshold. It can be further contemplated as another embodiment that each of the first and second detection deciders 713 and 719 calculates the Carrier-to-Interference and Noise Ratio (CINR) of MAX (or MAX_{SUM}) and determines whether to detect the feedback signal by comparing the CINR with a threshold.

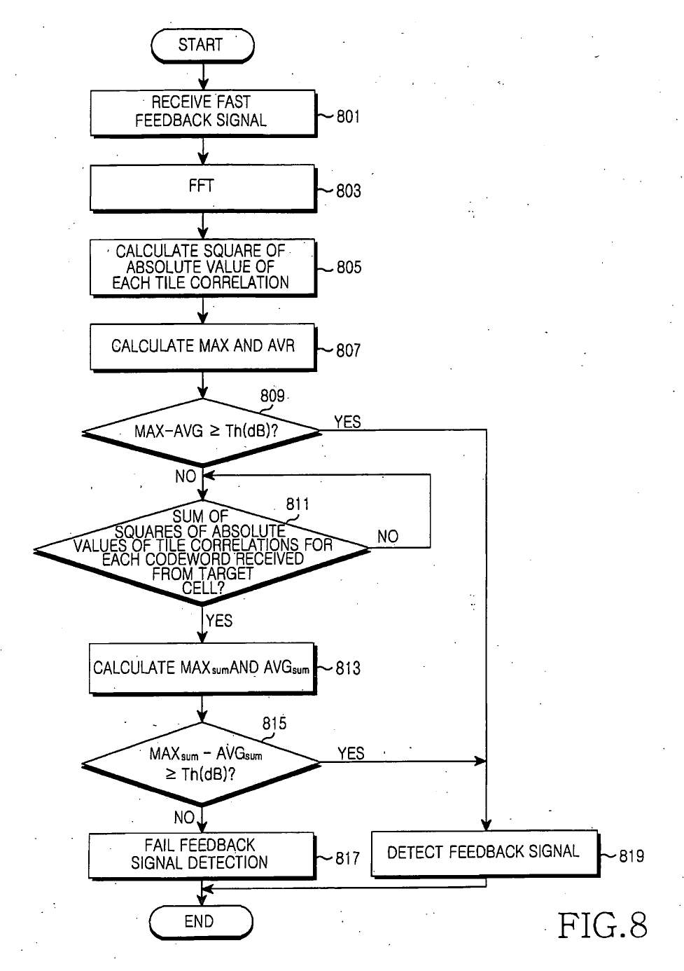

FIG. 8 is a flowchart illustrating a feedback information detecting operation according to the present invention.

Referring to FIG. 8, the BS monitors reception of an uplink fast feedback signal from a serving sector in step 801. Upon receipt of the feedback signal, the BS converts the received time-domain feedback signal to a frequency signal by FFT in step 803.

In step 805, the BS separates tiles from the FFT feedback signal, correlates modulation symbols on eight subcarriers and a pilot symbol on one subcarrier in each of the tiles with an orthogonal vector corresponding to the tile in every possible codeword and a transmission pilot symbol, and squares the absolute values of the correlations of the tiles for the codeword.

The BS sums the squares of the absolute values of the correlations of the tiles, for every codeword, selects the maximum (MAX) of the sums, and calculates the average (AVG) of the sums in step 807.

In step 809, the BS compares the difference between the maximum and the average with a threshold (Th). If the difference between the maximum and the average is greater than or equal to the threshold ((MAX−AVG)≧Th), the BS performs detection, considering that the received feedback information is reliable in step 819.

If the difference is less than the threshold ((MAX−AVG)<Th), the BS monitors reception of the sum of the squares of the absolute values of the correlations of the tiles carrying feedback information received in a target sector with every possible codeword from the target sector in step 811. The feedback signal from the MS within the serving sector is scattered under a channel environment and then reaches to the target sector. Thus, the target sector calculates the sum of the squares of the absolute values of the correlations of the feedback signal with respect to every possible codeword. Since the target sector has knowledge of the environment of the serving sector (e.g. information about slots allocated to the MS), it can carry out the correlation.

In step 813, for every possible codeword, the BS adds the sum of the squares of the absolute values of the correlations of the feedback signal received from the serving sector to the sum of the squares of the absolute values of the correlations of a feedback signal received from the target sector. The BS selects the maximum (MAX_{SUM}) of the sums and calculates the average (AVG_{SUM}) of the sums with respect to the 16 codewords.

In step 815, the BS compares the difference between the maximum sum and the average sum with a threshold (Th). If the difference between the maximum sum and the average sum is greater than or equal to the threshold ((MAX_{SUM}−AVG_{SUM})≧Th), the BS performs detection, considering that information data corresponding to a codeword with the maximum sum is reliable. Then the BS ends the algorithm.

If the difference is less than the threshold ((MAX−AVG)<Th), the BS discards the feedback signal without detection, considering that the feedback signal is not reliable in step 817. Then the BS ends the algorithm.

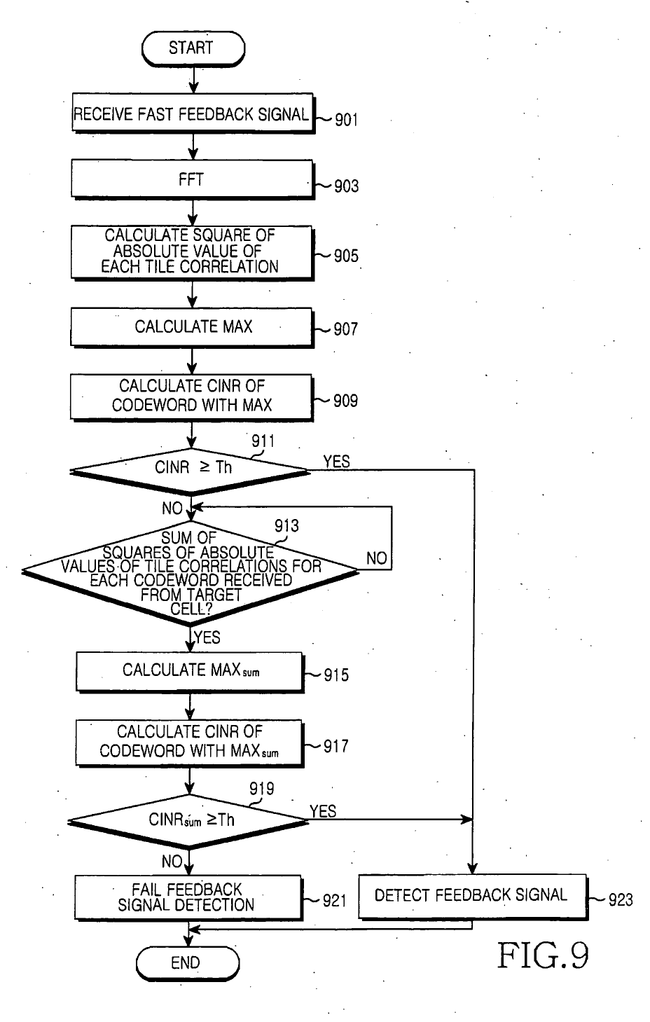

FIG. 9 is a flowchart illustrating a feedback information detecting operation according to another embodiment of the present invention.

Referring to FIG. 9, the BS monitors reception of an uplink fast feedback signal from a serving sector in step 901. Upon receipt of the feedback signal, the BS converts the received time-domain feedback signal to a frequency signal by FFT in step 903.

In step 905, the BS separates tiles from the FFT feedback signal, correlates modulation symbols on eight subcarriers and a pilot symbol on one subcarrier in each of the tiles with an orthogonal vector corresponding to the tile in every possible codeword and a transmission pilot symbol, and squares the absolute values of the correlations of the tiles for the codeword.

The BS sums the squares of the absolute values of the correlations of the tiles, for every codeword and selects a codeword with the maximum (MAX) of the sums in step 907.

The BS calculates the CINR of the feedback signal by estimating the transmit power and noise power of the feedback signal using the selected codeword in step 909. In step 911, the BS compares the CINR with a threshold (Th).

If the CINR is greater than or equal to the threshold (CINR≧Th), the BS performs detection, considering that information data corresponding to the codeword with the maximum is reliable in step 923.

If the CINR is less than the threshold (CINR<Th), the BS monitors reception of the sum of the squares of the absolute values of the correlations of the tiles carrying feedback information received in a target sector with every possible codeword from the target sector in step 913. The feedback signal from the MS within the serving sector is scattered under a channel environment and then reaches to the target sector. Thus, the target sector calculates the sum of the squares of the absolute values of the correlations of the feedback signal with respect to every possible codeword. Since the target sector has knowledge of the environment of the serving sector (e.g. information about slots allocated to the MS), it can carry out the correlation.

In step 915, for every possible codeword, the BS adds the sum of the squares of the absolute values of the correlations of the feedback signal received from the serving sector to the sum of the squares of the absolute values of the correlations of a feedback signal received from the target sector; The BS selects a codeword with the maximum (MAX_{SUM}) of the sums.

In step 917, the BS calculates the CINR (CINR_{SUM}) of the feedback signal by estimating the transmit power and noise power of the feedback signal using the selected codeword. The BS compares the CINR with a predetermined threshold (Th) in step 919.

If the CINR is greater than or equal to the threshold (CINR_{SUM}≧Th), the BS performs detection, considering that information data corresponding to the codeword with the maximum is reliable in step 923.

If the CINR is less than the threshold (CINR_{SUM}<Th), the BS discards the feedback signal, considering that the feedback signal is not reliable in step 921. The BS then ends the algorithm.

The above description has bee made in the context of a multi-sector BS. If more than one BS is simultaneously supported, a diversity gain can be achieved from a combination of the fast feedback signals from the BSs as well as from a combination of the fast feedback signals from the cells.

In accordance with the present invention as described above, uplink feedback information from an MS is detected using uplink fast feedback information from a target cell or sector as well as uplink fast feedback information from a serving cell or sector in a multi-cell or multi-sector BS in an OFDMA broadband wireless communication system. Therefore, accurate information transmission and stable system operation are achieved. Also, since the feedback information detection scheme is applicable irrespective of a subchannel structure, a tile structure, the number of bits in information data, and the number of receive antennas, the system operation is rendered flexible.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. An apparatus for detecting feedback information in a wireless communication system, comprising:
a demodulator for correlating modulation symbols and pilot symbols included in each tile carrying feedback information received from a serving sector for all codewords, each tile being a set of subcarriers, and calculating the squares of the absolute values of the correlations of the tiles;
a first detection decider for summing the squares of the absolute values of the correlations of the tiles for all codewords, and determining whether to perform detection on the received feedback information based on the sums for the possible codewords; and
a second detection decider for receiving feedback information from a target sector, combining the feedback information received from the serving sector with the feedback information received from the target sector, and determining whether to perform detection on the combined feedback information.

2. The apparatus of claim 1, wherein the demodulator comprises:
a tile de-allocator for separating the tiles from the feedback information received from the serving sector; and
at least one correlator for correlating the modulation symbols and pilot symbols included in each tile with each possible codeword, and calculating the squares of the absolute values of the correlations of the tiles for each possible codeword

3. The apparatus of claim 2, wherein the number of correlators for each tile is equal to the number of modulation symbols and pilot symbols per tile.

4. The apparatus of claim 1, wherein the demodulator correlates the modulation symbols and the pilot symbols on subcarriers of each tile with symbols corresponding to an orthogonal vector for each tile in each possible codeword and transmission pilot symbols.

5. The apparatus of claim 1, wherein the first detection decider comprises:
a codeword correlation calculator for summing the squares of the absolute values of the correlations of the tiles for each possible codeword and outputting the sums as first sums; and
a detection decider for comparing the difference between the maximum of the first sums and the average of the first sums with a threshold, and determining whether to perform detection on the received feedback information based on the comparison.

6. The apparatus of claim 5, wherein the detection decider determines that the feedback information received from the serving sector is reliable if the difference is greater than or equal to the threshold, and determines that the feedback information received from the serving sector is not reliable and sends the feedback information to the second detection decider if the difference is less than the threshold.

7. The apparatus of claim 5, wherein the first detection decider further comprises a calculator for calculating the Carrier-to-Interference and Noise Ratio (CINR) of a codeword with the maximum of the first sums, and wherein the detection decider compares the CINR with a threshold and determines whether to perform detection on the feedback information received from the serving sector according to the comparison.

8. The apparatus of claim 1, wherein the second detection decider starts to operate upon receipt of the feedback information from the first detection decider.

9. The apparatus of claim 1, wherein the second detection decider comprises:
a combiner for, if it is impossible to detect the feedback information received from the serving sector, receiving the feedback information from the target sector, combining the feedback information received from the serving sector with the feedback information received from the target sector, calculating the sum of the squares of the absolute values of the correlations of the tiles in the combined feedback information for each possible codeword, and outputting the sums for the possible codewords as second sums; and
a detection decider for comparing the difference between the maximum of the second sums and the average of the second sums with a threshold and determining whether to perform detection on the feedback information received from the serving sector and the target sector based on the comparison.

10. The apparatus of claim 9, wherein the detection decider determines that the feedback information received from the serving sector and the target sector is reliable if the difference is greater than or equal to the threshold, and determines that the feedback information received from the serving sector and the target sector is not reliable and discards the feedback information if the difference is less than the threshold.

11. The apparatus of claim 9, wherein the second detection decider further comprises a calculator for calculating the CINR of a codeword with the maximum of the second sums, and wherein the detection decider compares the CINR with a threshold and determines whether to perform detection on the feedback information received from the serving sector and the target sector based on the comparison.

12. The apparatus of claim 1, further comprising:
a first detector for detecting the feedback information received from the serving sector if the first detection decider determines to perform detection on the feedback information received from the serving sector; and
a second detector for detecting the feedback information received from the serving sector and the target sector if the second detection decider determines to perform detection on the feedback information received from the serving sector and the target sector.

13. A method of detecting feedback information in a wireless communication system, comprising the steps of:
determining whether to perform detection on feedback information received from a serving sector;
receiving feedback information from a target sector; and
combining the feedback information received from the serving sector with the feedback information received from the target sector, and determining whether to perform detection on the combined feedback information.

14. The method of claim 13, wherein the step of determining whether to perform detection on feedback information received from a serving sector comprises:
separating tiles from the feedback information received from the serving sector, each tile being a set of subcarriers, correlating each tile carrying the feedback information received from the serving sector with each possible codeword, and calculating the squares of the absolute values of the correlations of the tiles for each possible codeword;
summing the squares of the absolute values of the correlations of the tiles for each possible codeword and outputting the sums for the possible codewords as first sums;
comparing the difference between the maximum of the first sums and the average of the first sums with a threshold; and
determining that it is impossible to detect the feedback information received from the serving sector if the difference is less than the threshold.

15. The method of claim 14, further comprising the step of performing detection on the feedback information received form the serving sector if the difference is greater than or equal to the threshold.

16. The method of claim 14, wherein the correlation step comprises correlating modulation symbols and pilot symbols on subcarriers of each tile with orthogonal vectors corresponding to each codeword for each tile and transmission pilot symbols.

17. The method of claim 13, wherein the step of determining whether to perform detection on the combined feedback information comprises:
calculating the sum of the squares of the absolute values of the correlations of the tiles in the combined feedback information for each possible codeword, and outputting the sums for the possible codewords as second sums;
comparing the difference between the maximum of the second sums and the average of the second sums with a threshold; and
determining to perform detection on the combined feedback information if the difference is greater than or equal to the threshold.

18. The method of claim 17, further comprising determining that it is impossible to detect the combined feedback information and discarding the combined feedback information if the difference is less than the threshold.

19. The method of claim 13, wherein the step of determining whether to perform detection on feedback information received from a serving sector comprises:
separating tiles from the feedback information received from the serving sector, each tile being a set of subcarriers, correlating each tile carrying the feedback information received from the serving sector with each possible codeword, and calculating the squares of the absolute values of the correlations of the tiles for each possible codeword;
summing the squares of the absolute values of the correlations of the tiles for each possible codeword and outputting sums for the possible codewords as first sums;
calculating the Carrier-to-Interference and Noise Ratio (CINR) of a codeword with the maximum of the first sums and comparing the CINR with a threshold; and
determining that it is impossible to detect the feedback information received from the serving sector if the CINR is less than the threshold.

20. The method of claim 19, further comprising performing detection on the feedback information received form the serving sector if the CINR is greater than or equal to the threshold.

21. The method of claim 19, wherein the CINR calculation step comprises calculating the CINR of the codeword with the maximum of the second sums using estimated signal power and noise power of the codeword.

22. The method of claim 13, wherein the step of determining whether to perform detection on the combined feedback information comprises:
calculating the sum of the squares of the absolute values of the correlations of the tiles in the combined feedback information for each possible codeword, and outputting the sums for the possible codewords as second sums;
calculating the CINR of a codeword with the maximum of the second sums and comparing the CINR with a threshold; and
performing detection on the combined feedback information if the CINR is greater than or equal to the threshold.

23. The method of claim 22, further comprising determining that it is impossible to detect the combined feedback information and discarding the combined feedback information if the CINR is less than the threshold.

24. An apparatus for detecting feedback information in a wireless communication system, comprising:
a demodulator for correlating modulation symbols and pilot symbols included in each tile carrying feedback information received from a serving cell for all codewords, each tile being a set of subcarriers, and calculating the squares of the absolute values of the correlations of the tiles for all codeword;
a first detection decider for summing the squares of the absolute values of the correlations of the tiles for all codewords, and determining whether to perform detection on the received feedback information based on the sums for all the codewords; and
a second detection decider for receiving feedback information from a target cell, combining the feedback information received from the serving cell with the feedback information received from the target cell, and determining whether to perform detection on the combined feedback information.

25. The apparatus of claim 24, wherein the demodulator comprises:
a tile de-allocator for separating the tiles from the feedback information received from the serving cell; and
at least one correlator for correlating the modulation symbols and pilot symbols included in each tile with each possible codeword, and calculating the squares of the absolute values of the correlations of the tiles for each possible codeword

26. The apparatus of claim 25, wherein the number of correlators for each tile is equal to the number of modulation symbols and pilot symbols per tile.

27. The apparatus of claim 24, wherein the demodulator correlates the modulation symbols and the pilot symbols on subcarriers of each tile with symbols corresponding to an orthogonal vector for each tile in each possible codeword and transmission pilot symbols.

28. The apparatus of claim 24, wherein the first detection decider comprises:
a codeword correlation calculator for summing the squares of the absolute values of the correlations of the tiles for each possible codeword and outputting the sums as first sums; and
a detection decider for comparing the difference between the maximum of the first sums and the average of the first sums with a threshold, and determining whether to perform detection on the received feedback information based on the comparison.

29. The apparatus of claim 28, wherein the detection decider determines that the feedback information received from the serving cell is reliable if the difference is greater than or equal to the threshold, and determines that the feedback information received from the serving cell is not reliable and sends the feedback information to the second detection decider if the difference is less than the threshold.

30. The apparatus of claim 28, wherein the first detection decider further comprises a calculator for calculating the Carrier-to-Interference and Noise Ratio (CINR) of a codeword with the maximum of the first sums, and wherein the detection decider compares the CINR with a threshold and determines whether to perform detection on the feedback information received from the serving cell based on the comparison.

31. The apparatus of claim 24, wherein the second detection decider starts to operate upon receipt of the feedback information from the first detection decider.

32. The apparatus of claim 24, wherein the second detection decider comprises:
a combiner for, if it is impossible to detect the feedback information received from the serving cell, receiving the feedback information from the target cell, combining the feedback information received from the serving cell with the feedback information received from the target cell, calculating the sum of the squares of the absolute values of the correlations of the tiles in the combined feedback information for each possible codeword, and outputting the sums for the possible codewords as second sums; and
a detection decider for comparing the difference between the maximum of the second sums and the average of the second sums with a threshold and determining whether to perform detection on the feedback information received from the serving cell and the target cell based on the comparison.

33. The apparatus of claim 32, wherein the detection decider determines that the feedback information received from the serving cell and the target cell is reliable if the difference is greater than or equal to the threshold, and determines that the feedback information received from the serving cell and the target cell is not reliable and discards the feedback information if the difference is less than the threshold.

34. The apparatus of claim 32, wherein the second detection decider further comprises a calculator for calculating the CINR of a codeword with the maximum of the second sums, and wherein the detection decider compares the CINR with a threshold and determines whether to perform detection on the feedback information received from the serving cell and the target cell based on the comparison.

35. The apparatus of claim 24, further comprising:
a first detector for detecting the feedback information received from the serving cell if the first detection decider determines to perform detection on the feedback information received from the serving cell; and
a second detector for detecting the feedback information received from the serving cell and the target cell if the second detection decider determines to perform detection on the feedback information received from the serving cell and the target cell.

36. A method of detecting feedback information in a wireless communication system, comprising the steps of:
determining whether to perform detection on feedback information received from a serving cell;
receiving feedback information from a target cell; and
combining the feedback information received from the serving cell with the feedback information received from the target cell when receiving the feedback information from the target cell, and determining whether to perform detection on the combined feedback information.

37. The method of claim 36, wherein the step of determining whether to perform detection on feedback information received from a serving cell comprises:
separating tiles from the feedback information received from the serving cell, each tile being a set of subcarriers, correlating each tile carrying the feedback information received from the serving cell with each possible codeword, and calculating the squares of the absolute values of the correlations of the tiles for each possible codeword;
summing the squares of the absolute values of the correlations of the tiles for each possible codeword and outputting the sums for the possible codewords as first sums;
comparing the difference between the maximum of the first sums and the average of the first sums with a threshold; and
determining that it is impossible to detect the feedback information received from the serving cell if the difference is less than the threshold.

38. The method of claim 37, further comprising performing detection on the feedback information received form the serving cell if the difference is greater than or equal to the threshold.

39. The method of claim 37, wherein the correlation step comprises correlating modulation symbols and pilot symbols on subcarriers of each tile with symbols corresponding to an orthogonal vector for each tile in each possible codeword and transmission pilot symbols.

40. The method of claim 36, wherein the step of determining whether to perform detection on the combined feedback information comprises:
calculating the sum of the squares of the absolute values of the correlations of the tiles in the combined feedback information for each possible codeword, and outputting the sums for the possible codewords as second sums;
comparing the difference between the maximum of the second sums and the average of the second sums with a threshold; and
determining to perform detection on the combined feedback information if the difference is greater than or equal to the threshold.

41. The method of claim 40, further comprising determining that it is impossible to detect the combined feedback information and discarding the combined feedback information if the difference is less than the threshold.

42. The method of claim 36, wherein the step of determining whether to perform detection on feedback information received from a serving cell comprises:
separating tiles from the feedback information received from the serving cell, each tile being a set of subcarriers, correlating each tile carrying the feedback information received from the serving cell with each possible codeword, and calculating the squares of the absolute values of the correlations of the tiles for each possible codeword;
summing the squares of the absolute values of the correlations of the tiles for each possible codeword and outputting sums for the possible codewords as first sums;
calculating the Carrier-to-Interference and Noise Ratio (CINR) of a codeword with the maximum of the first sums and comparing the CINR with a threshold; and
determining that it is impossible to detect the feedback information received from the serving cell if the CINR is less than the threshold.

43. The method of claim 42, further comprising performing detection on the feedback information received form the serving cell if the CINR is greater than or equal to the threshold.

44. The method of claim 42, wherein the CINR calculation step comprises calculating the CINR of the codeword with the maximum of the second sums using estimated signal power and noise power of the codeword.

45. The method of claim 36, wherein the step of determining whether to perform detection on the combined feedback information comprises:
calculating the sum of the squares of the absolute values of the correlations of the tiles in the combined feedback information for each possible codeword, and outputting the sums for the possible codewords as second sums;
calculating the CINR of a codeword with the maximum of the second sums and comparing the CINR with a predetermined threshold; and
performing detection on the combined feedback information if the CINR is greater than or equal to the threshold.

46. The method of claim 45, further comprising determining that it is impossible to detect the combined feedback information and discarding the combined feedback information if the CINR is less than the threshold.

47. An apparatus for detecting feedback information in a wireless communication system, comprising:
a demodulator for correlating modulation symbols and pilot symbols with orthogonal vectors corresponding to codewords and the transmitted pilot symbols respectively; and
a channel decoder for summing the squares of the absolute values of the correlations of the tiles for each codeword, and combining the feedback information received from the serving sector with the feedback information received from the target sector, and determining whether to perform detection on the combined feedback information.
